(19) United States
(12) Patent Application Publication
(10) Pub. No.: US 2005/0184415 A1
(43) Pub. Date: Aug. 25, 2005

(54) Method for producing extruded products

(76) Inventor: Masaki Ohashi, Aichi-ken (JP)

Correspondence Address: POSZ LAW GROUP, PLC, 12040 SOUTH LAKES DRIVE, SUITE 101, RESTON, VA, 20191, US

(21) Appl. No.: 11/049,299

(22) Filed: Feb. 3, 2005

(30) Foreign Application Priority Data
Feb. 6, 2004 (JP) P2004-030204
Feb. 19, 2004 (JP) P2004-043091
Feb. 20, 2004 (JP) P2004-044086

(51) Int. Cl. B29C 47/92

(52) U.S. Cl. 264/40.1; 264/211.23

(57) ABSTRACT

In a method for producing many extruded products having different specifications in the same production line, a continuous extruded products is extrusion molded. A symbol is attached to the surface of the continuous extruded products on the basis of the specification data of a product to be subsequently produced from a process controller. The extruded products is conveyed to a processing step. In the processing step, the image of the symbol provided on the surface of the extruded products is recognized. A product identification signal based on the recognition of the image is transmitted to the process controller to carry out a predetermined process thereto. The process controller selects the specification data of the product and sends the specification data of the product to the processing step. A processing work based on the specification data of the product is automatically switched to produce the many extruded products having the different specifications in the same production line.

### BACKGROUND OF THE INVENTION

1. Field of the Invention

The present invention relates to a method for producing extruded products such as a weather strip for a vehicle formed by an extrusion molding that is used for sealing a part between a door body such as a door or a trunk lid of the vehicle and an opening part of a vehicle body. More particularly, the present invention relates to a method for producing extruded products in which many extruded products having different specifications are produced in the same one production line. The production line means a line in which many processes are continuously arranged substantially linearly or in a substantially curved line.

Further, the present invention relates to a method for forming extruded products in which a cover layer is formed on the surface of a extruded product main body.

2. Description of the Related Art

The extruded products such as the weather strip for the vehicle are formed by the extrusion molding. In this case, a material such as synthetic rubber, thermoplastic elastomer, etc. is used and extrusion molded. After the extrusion molding, in the case of the synthetic rubber, the synthetic rubber is vulcanized in a vulcanizing device to form the continuous extruded products. Then, for instance, after a sealant filling process that a U shaped inside of a trim part formed in a substantially U shape in section is filled with a sealant or a cutting process for cutting the extruded products to a predetermined dimension is carried out, a part corresponding to a corner part of the vehicle body is formed by an injection molding process to have a molded part such as the weather strip for the vehicle. See JP-A-6-106597 (pages 3 to 5, FIG. 4), for instance.

In producing the weather strip for the vehicle, the extruded products are ordinarily formed by the extrusion molding process and then cut to a predetermined dimension. The basic sectional forms of the weather strips for the vehicles are the same. However, the weather strips have various kinds of specifications depending on the types of the vehicle, or depending on the right and left sides, the front side and the rear side of the same type of the vehicle or depending on dimensions, the forms of molding, the filling positions of the sealant, the cut part of a cover lip extending from the trim part or the like.

When the many kinds of weather strips are fabricated, as shown in FIG. 15A, the continuous extruded products are continuously formed by the extrusion molding process. That is, a metal plate wound on a reel that is not shown in the drawing is firstly prepared. The metal plate is supplied to an insert punching machine 101 to punch and form a long strip shaped insert 154 connected in connecting parts from the metal plate. Then, the insert 154 is supplied to a pre-forming machine 102 to slightly perform a bending work so that the extrusion molding process as a next process can be easily carried out. Further, the insert 154 is supplied to an extruding head 105 of extruders 103 and 104 to cover the insert 154 with each material and form the weather strip 100 Here, the first extruder 103 extrudes a solid material for forming the trim part of the weather strip 100. The second extruder 104 extrudes a sponge material for forming a hollow seal part of the weather strip 100. Then, the weather strip 100 is conveyed to a vulcanizing device 108 and heated and vulcanized by hot air or UHF.

The insert 154 is embedded in the trim part and covered with the solid material.

The vulcanized continuous extruded product (the weather strip 100) is cut to a predetermined dimension for each number of goods. The extruded products cut to the predetermined dimension are respectively individually processed in separate processes (different producing places) depending on the specifications of products, for instance, processes such as filling the trim part with the sealant, partly cutting the cover lip extending from the trim part, the molding of a terminal end part or the like. Accordingly, a continuous processing operation is undesirably difficult in the same production line. Further, it takes time or labor to convey the extruded products between the processes. Thus, the processes required until a final product is manufactured have been undesirably hardly automated.

Moreover, in such the case, to make accurate the dimension of the product to be cut or to make easy a processing work carried out before the extruded product is cut by clearly grasping the front end of the product after the continuous extruded product is cut, notch portions are attempted to be provided in an insert embedded in the extruded product.

When the notch portions are provided in the insert 154 formed in a ladder shape by punching the metal plate, as shown in FIG. 16, the notch portions are provided at predetermined intervals in a punching part 111 by using an insert punching machine 110. To provide the notch portions at predetermined intervals, the notch portion is firstly provided in the insert of a part embedded in the front end of the extruded product. Then, the insert 154 is moved. A detecting part 116 is provided for detecting a time when the notch portion at the front end reaches a predetermined distance. A notch portion at a rear end is punched in the punching part 111 in accordance with a signal detected by the detecting part 116.

When the product is changed to a product having a different dimension of the extruded products, that is, a product having a different length of the insert 154, a movement adjusting roller 114 is moved upward and downward to adjust the dimension of the insert 154 between the detecting part 116 and the punching part 11.

However, as shown in FIG. 15A, to efficiently perform producing processes, many kinds of inserts 154 having different longitudinal dimensions are continuously formed in one production line having a series of flow from a forming process and an extrusion molding process to a vulcanizing process of the insert 154.

Therefore, to adjust the dimension of the insert 154 between the detecting part 116 and the punching part 111, the movement adjusting roller 114 needs to be moved during forming the notch portions of the insert 154. However, to assuredly feed the insert 154, the movement adjusting roller 114 cannot be rapidly moved. Accordingly, during moving the movement adjusting roller 114, the notch portions are sometimes formed and the insert 154 has a different dimension from the predetermined dimension. Thus, the insert 154 cannot be sometimes undesirably used as a product.

Further, when the processes such as filling of the sealant, cutting of the cover lip or the like are continuously carried out before the extruded products are cut, processing operations need to be carried out in positions respectively adapted to the specifications of the products. However, since the external appearances of the extruded products are respectively the same, the extruded products are respectively hardly identified from their external appearances. Therefore, one specification of the extruded products is determined to produce several tens of the extruded products. Every time the extruded products changes and the specification of the product changes, the setting of the cover lip, the cutting position or the filling position of the sealant is changed and several tens of the extruded products are respectively produced to meet the above described changes See JP-B-2-12174 (pages 2 to 3), for instance.

Consequently, to produce the extruded products having the different specifications in one line, every time the specification of the product is changed, the processing operation and processing conditions are changed. Thus, since production efficiency is not good, the production efficiency has been desired to be improved.

Moreover, in the case of the weather strip for the vehicle, a main body thereof is ordinarily formed with synthetic rubber or thermoplastic elastomer. In this case, most of the weather strip main bodies are formed in black color owing to the relation with a mixing material.

However, to improve a harmonization with interior finish parts of the interior of the vehicle and an outward appearance, products having various kinds of colors have been needed. Further, to improve a weather resistance or a chemical resistance, a special material has needed to be provided on a surface.

For meeting the above-described requests, a colored thin layer has been provided on the surface of the extruded goods main body that is extrusion molded such as the weather strip for the vehicle.

When a cover layer is provided on the main body of the weather strip 1 as the extruded product, a weather strip main body 1b formed by an extrusion molding process and vulcanized in a vulcanizing device (not shown in the drawing) is pre-formed so as to be slightly bent by a primary pre-forming machine 2 as shown in FIG. 15B. Then, an adhesive agent or a primer is applied to the weather strip main body 1b by an adhesive or primer applicator 3. Further, the cover layer is extrusion molded in the form of a sheet by an extruding die 140 connected to an extruder 110. After that, the cover layer extruded in the form of the sheet is attached under pressure to the weather strip main body 1b to bond the cover layer to the weather strip main body 1b by a bonding machine 4. Further, the weather strip 1 cooled by a cooling device 5 is pulled by a sending machine 6. see JP-A-8-174620 (pages 2 to 4, FIGS. 1 to 4) for instance.

Subsequently, the weather strip is cut to a predetermined dimension and a corner part or the like undergoes an injection molding process as required to obtain a molded part.

In this case, when the extrusion molding process of the weather strip main body 1b is stopped, if a material in the extruder (not shown in the drawing) is the synthetic rubber, the synthetic rubber may begin to be solidified, which is a phenomenon, what is called “scorch”. Therefore, to improve a productive efficiency, the weather strip 1 is produced in a continuous production line from the extrusion molding process of the weather strip main body 1b until the weather strip 1 is pulled by the sending machine 6. As the cover layer, the cover layers having many kinds of colors are required depending on the colors of the interior finish products of the vehicle and the extruding material of the extruder 110 for the cover layer needs to be changed many times.

When the extruding material of the extruder 110 is replaced by another extruding material, a new material is supplied from the rear part of the extruder 110. Then, an old material present in a screw (cylinder), an extruding head or an extruding die in the extruder is extruded and discharged to replace the old material by the new material.

However, in the screw, the extruding head or the extruding die, the old material is mixed with the new material and the mixture is retained, so that it takes long time to replace the old material by the new material.

### SUMMARY OF THE INVENTION

It is an object of the present invention to efficiently produce many kinds of extruded products having different specifications in one production line by automatically changing processing conditions to those meeting a specification every time the specification of the extruded products is changed.

In the invention, whereas many extruded products having different specifications are produced in one production line, a movement amount of a movement adjusting roller is decreased and the change of the dimension of an insert is rapidly adjusted such that the occurrence of the defective product of the insert is prevented to thereby improve the productive efficiency of the extruded products.

Further, during that time, the weather strip main body is continuously extrusion molded and passes the extruder of the cover layer. Thus, the weather strip main body is continuously covered with the cover layer having the old material mixed with the new material.

Accordingly, the weather strip having a part of the cover layer in which the old material is mixed with the new material forms a defective product. Therefore, while the weather strip main body is continuously extrusion molded, the old material of the cover layer needs to be quickly replaced by the new material. (

1) In order to solve the above-described problems, the present invention provides a method for producing extruded products of plural specifications in a single production line controlled by a process controller; said method comprising:

an extrusion step of extruding a continuous extruded product by an extrusion molding in accordance with a signal from the process controller;

a symbol providing step of providing a symbol on a surface of the extruded product during the extrusion molding based on a predetermined specification data from the process controller; and

a processing step of processing the long molded part;

wherein the processing step includes:

recognizing an image of the symbol provided on the surface of the extruded product;

transmitting a product identification signal based on the recognized image to the process controller, identifying the extruded product to be produced in accordance with the product identification signal in the process controller,

selecting a specification data of the extruded product based on the production identification signal in the process controller,

sending the specification data to a processing system,

performing a predetermined processing work in accordance with the specification data to the extruded product in the processing system;

wherein the processing work based on the specification data is automatically switchable so that the plural extruded products having the different specifications are formed in the single production line.

In the invention as described foregoing, the extruded products can be continuously extrusion molded. The identifiable symbols can be attached to the surfaces of the extruded products to be processed afterward before the extruded products are cut on the basis of the specification data of the products of the extruded products to be produced. Then, in the processing step, the extruded products to be produced can be specified and a predetermined process can be carried out thereto. Thus, in the processing step after the extrusion molding process, necessary processing conditions can be changed on the basis of the symbols and the extruded products having the different specifications can be continuously produced in the same production line.

In the processing step or in a step before the processing step, the images of the symbols provided on the surfaces of the extruded products are recognized. The product identification signals based on the recognition of the images are transmitted to the process controller. The process controller identifies the extruded products to be produced, selects the specification data of the products and sends the specification data of the products to the processing step. In the processing step, the predetermined process can be carried out to the extruded products. Further, identifying symbols are recognized by using an image recognizing device without stopping the production of the extruded products to transmit the product identification signals to the process controller. Then, the process controller selects the relevant number of goods of the extruded products to be produced that are previously stored in accordance with the symbols. The process controller selects the specification data of the products that is previously stored from the data of the relevant number of goods and transmits the specification data of the products such as corresponding dimensions or the processing conditions to the processing step.

Further, in the processing step, the processing operation can be automatically switched on the basis of the specification data of the products so that many extruded products having the different specifications can be formed in the same production line. Accordingly, while the extruded products are continuously extrusion molded, the specification data of the products can be transmitted and received without stopping the production line. A processing device in the processing step can recognize the extruded products that are subsequently supplied to the production line to carry out a predetermined process thereto.

Consequently, many kinds of extruded products having the different specifications can be automatically changed and processed in accordance with the specifications continuously from the extrusion molding process. Thus, many kinds of products can be produced in one production line by quickly switching.

Another aspect of the invention provides a method for producing extruded products of plural specifications in a single production line controlled by a process controller; said method comprising the steps of:

a notch forming step of forming a notch portion in a metal insert based on a predetermined specification data of the extruded product to be produced from the process controller;

an extruding step of extruding a continuous extruded product so as to embed the metal insert with the notch portion by extrusion molding;

a processing step of processing the long molded part;

wherein the processing step includes:

detecting the notch portion embedded in the extruded product by a sensor,

transmitting a signal from the sensor to the process controller,

identifying the extruded product to be produced in accordance with the signal from the sensor in the process controller,

selecting a specification data of the extruded product of the extruded product in accordance with the extruded product to be produced; and

sending the specification data to a processing system,

performing a predetermined processing work in accordance with the specification data to the extruded product in the processing system;

wherein a processing work based on the specification data is automatically switchable so that the plural extruded products having the different specifications are formed in the single production line.

According to another aspect of the invention, the extruded products having the different specifications can be automatically produced by the notch portions of the metal inserts of the extruded products to be produced and the specification data of the products from the process controller.

Further, the embedded metal inserts can improve the rigidity of the extruded products and unevenness in dimension in the longitudinal direction of the extruded products can be eliminated by the metal inserts. Further, the dimension of length (conveying dimension) of the extruded products can be properly detected owing to the notch portions provided in the inserts.

In the processing step or in a step before the processing step, the notch portions of the metal inserts embedded in the extruded products are detected by the sensor and the signals from the sensor are transmitted to the process controller. The process controller identifies the extruded products to be produced, selects the specification data of the products and sends the specification data of the products to the processing step. In the processing step, the predetermined process can be carried out to the extruded products. Further, the sensor recognizes the notch portions of the metal inserts without stopping the production of the extruded products to transmit dimension signals of the extruded products to the process controller. Then, the process controller collates the dimension data of the extruded products to be produced that is previously stored with the signals to select the specification data of the products of a corresponding number of goods and transmit the specification data of the products such as corresponding processing conditions to the processing step.

Further, in the processing step, the processing operation can be automatically switched on the basis of the specification data of the products so that many extruded products having the different specifications can be formed in the same production line. Accordingly, while the extruded products are continuously extrusion molded, the specification data of the products can be transmitted and received without stopping the production line. A processing device in the processing step can recognize the extruded products that are subsequently supplied to the production line to carry out a predetermined process such as a cutting process thereto.

Another aspect of the invention provides the method for producing extruded products wherein in the processing step, both the product identification signals obtained by recognizing the images of the symbols provided on the surfaces of the extruded products and the signals obtained by detecting the notch portions of the metal inserts by the sensor are used to perform a processing operation.

In the invention, the types and dimensions of the products can be properly recognized from both the signals and a proper command of the processing operation can be outputted in accordance with the contents of processes.

Another aspect of the invention provides the method for producing extruded products in which the extruded product is a weather strip for sealing the peripheral portion of an opening part of a vehicle.

In the invention, for instance, in accordance with the signal due to the notch portions of the metal inserts embedded in a trim part having a substantially U shape in section in the weather strip and the signal due to the symbol attached on the surface of the trim part, the dimension of length of the weather strip can be precisely grasped and cut. Further, processes can be carried out, for instance, a cover lip extending from the trim part is cut or the inside part of the trim part is filled with a sealant. Further, the extruded products having the same sectional forms and different in longitudinal dimension or the extruded products having the same dimension and bilaterally symmetrical forms used in the right side and the left side of the vehicle can be precisely produced.

Another aspect of the invention provides the method for producing extruded products wherein the processing step is a step for cutting the continuous extruded products to a predetermined dimension.

In the invention, many kinds of extruded products having the same external forms and different longitudinal dimensions can be respectively cut to the predetermined dimensions without stopping the extrusion molding process. The settings of the dimensions of the many kinds of extruded products are respectively automatically changed in accordance with the specification data of the products in the process controller to cut the extruded products. Therefore, the many kinds of extruded products can be efficiently produced in one production line.

Another aspect of the invention provides the method for producing extruded products wherein the processing step is a step for filling the inner part of the trim part of the weather strip with the sealant.

In the invention, many kinds of extruded products having the same external forms except their length and different longitudinal dimensions or the extruded products having the same longitudinal dimension but different in their filling positions of the sealant or amount of filling of the sealant can be respectively filled with the sealant to the predetermined dimensions and positions without stopping the production line. The settings of the filling positions of the sealant of the many kinds of extruded products are respectively automatically changed in accordance with the specification data of the products in the process controller to fill the extruded products with the sealant. Therefore, the many kinds of extruded products can be efficiently produced in one production line.

Another aspect of the invention provides the method for producing extruded products wherein the processing step is a step for partly cutting the cover lip of the weather strip by a predetermined dimension at a predetermined position.

In the invention, in the many kinds of extruded products having the same external forms and different longitudinal dimensions and different in their cutting positions of the cover lips or amount of cutting of the cover lips, the cover lips can be respectively partly cut to the predetermined dimensions, the positions and the amount of cutting without stopping the production line. The settings of the cutting positions of the cover lips of the many kinds of extruded products are respectively automatically changed in accordance with the specification data of the products in the process controller to cut the cover lips. Therefore, the many kinds of extruded products can be efficiently produced in one production line.

According to the present invention, in the processing step or the step before the processing step, the images of the symbols provided on the surfaces of the extruded products are recognized or the notch portions provided in the metal inserts are detected to transmit the signals for identifying the products to the process controller. The process controller identifies the extruded products to be produced, selects the specification data of the products and transmits the specification data of the products to the processing step. In the processing step, the predetermined process is carried out to the extruded products. Accordingly, the product identification signals can be transmitted to the process controller without stopping the extrusion molding process of the extruded products. Further, the process controller collates the specification data of the products of the number of goods of the extruded products to be produced that is previously stored with the symbols so that the process controller can select the specification data of the products of the corresponding number of goods.

The processing device in the processing step that receives the specification data of the products can recognize the extruded products that is subsequently supplied to the production line on the basis of the specification data of the products to carry out the predetermined process thereto.

Accordingly, the many kinds of extruded products to be produced can be automatically changed and processed in accordance with the specification data of the products of the many kinds of lengthy products to be produced via some processes continuously from the extrusion molding process. Thus, the many kinds of products can be efficiently produced in one production line by quickly switching the processing conditions.

Further, even when the longitudinal dimension of one extruded product is different, the insert can be continuously processed without stopping the processing operation of the insert. Processing conditions can be automatically changed on the basis of the specification data of products from a process controller. Thus, the dimension of the extruded products can be frequently changed and many kinds of products can be properly produced in the same production line.

Further, in the present invention, the step for extrusion molding the extruded product main body and the step for forming the cover layers can realize a continuous production line. Further, since a selector valve is switched to extrusion mold the cover layer made of different extrusion molding materials, a extruded product extrusion molding controller sends a signal for forming a product having different cover layers to the selector valve. Thus, the material of the cover layer can be automatically and properly switched in accordance with kinds of products to be produced. Many kinds of products can be automatically, assuredly and rapidly produced in one production line.

### BRIEF DESCRIPTION OF THE DRAWINGS

FIG. 1 shows a sectional form of a weather strip for a vehicle produced by a producing method according to an embodiment of the present invention;

FIG. 2 is a schematic view of a process for extrusion molding the weather strip in the producing method according to the embodiment of the present invention;

FIG. 3 is a partial perspective view showing a part in which an identifying symbol is attached to the weather strip before the weather strip is bent to a U shape and notch portions of an insert in the producing method according to the embodiment of the present invention;

FIG. 4 is a partial perspective view showing the part in which the identifying symbol is attached to the weather strip after the weather strip is bent to the U shape and the notch portions of the insert in the producing method according to the embodiment of the present invention;

FIG. 5 is a perspective view of a cover lip cutting machine of the weather strip in the producing method according to the embodiment of the present invention;

FIG. 6 is a schematic view of a process for cutting the cover lip of the weather strip in the producing method according to the embodiment of the present invention;

FIG. 7 is a perspective view of a sealant filling machine of the weather strip in the producing method according to the embodiment of the present invention;

FIG. 8 is a schematic view of a process for detecting the notch portion of the insert of the weather strip in the producing method according to the embodiment of the present invention;

FIG. 9 is a perspective view of a cutting device of the weather strip in the producing method according to the embodiment of the present invention;

FIG. 10 is a sectional view of a part near a sensor for detecting the notch portion of the insert of the weather strip in the producing method according to the embodiment of the present invention;

FIG. 11 is a front view of an insert punching machine of the weather strip in the producing method according to the embodiment of the present invention;

FIG. 12 is a sectional view showing a process of extruding the cover layer according to second embodiment of the invention;

FIG. 13 is a partial detailed sectional view showing head, selector valve and extruding die in the extruder for extruding the cover layer in FIG. 12;

FIG. 14 is a schematic view showing a part of a production line of the weather strip according to second embodiment of the invention;

FIG. 15A is a schematic view of a process for extrusion molding a weather strip in a usual producing method;

FIG. 15B is a schematic view of a manufacturing process of a conventional producing method; and

FIG. 16 is a front view of a usual insert punching machine of a weather strip.

### DETAILED DESCRIPTION OF THE PREFERRED EMBODIMENTS

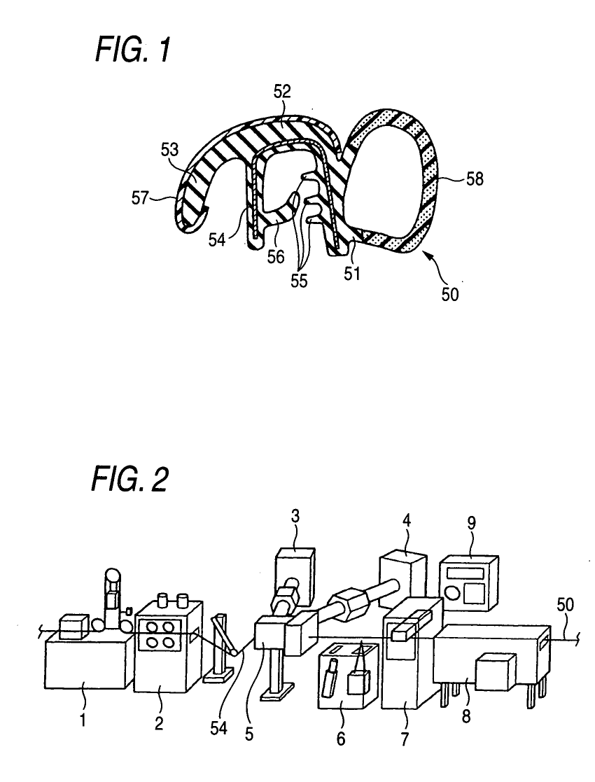

Embodiments of the present invention will be described with reference to FIGS. 1 to 14. The present invention is described by way of a weather strip for a vehicle as an example, however, the present invention may be employed for extruded products formed by other extrusion molding process.

First Embodiment

FIG. 1 is a sectional view of a weather strip 50 of first embodiment for a vehicle produced by a producing method according to the present invention. The weather strip 50 includes a weather strip main body 51 composed of a trim part 52 having a substantially U shape in section and a hollow seal part 58 protruding outward the vehicle from the trim part 52 and a decoration layer 57 provided on the upper surfaces of the trim part 52 and a below-described cover lip 53.

The trim part 52 has the substantially U shape in section and an insert 54 embedded therein. The trim part has the cover lip 53 extending inside the interior of the vehicle in an upper part. The cover lip 53 is partly cut at a predetermined position as described below. Further, as described below, the insert 54 is provided with notch portions 54b at the positions of a front end and a rear end of one extruded product. In the inner surface of the substantially U shape in section of the trim part 52, a plurality of outer holding lips 55 of the vehicle and one inner holding lip 56 of the vehicle are provided. Flanges of a door or an opening edge of a vehicle body are inserted into the inner part of the trim part 52 and held by the outer holding lips 55 of the vehicle and the inner holding lip 56 of the vehicle, Thus, the weather strip 50 is attached to the vehicle.

The trim part 52 is formed with a solid material such as rubber, thermoplastic elastomer, a soft synthetic resin or a fine foamed material. The hollow seal part 58 is formed with a sponge material such as rubber, thermoplastic elastomer, etc.

On the upper surface of the trim part 52 and the upper surface of the cover lip 53, the decoration layer 57 as a cover layer is fixed. Since the upper surface of the trim part 52 and the upper surface of the cover lip 53 are seen from the interior of the vehicle, the color of the decoration layer 57 needs to be changed so as to meet the color of an interior finish of the vehicle in view of its design. Accordingly, the decoration layer 57 having many kinds of colors is employed.

The decoration layer 57 is formed with the solid material such as the elastomer or the soft synthetic resin or the fine foamed material. A fabric may be stuck thereto.

Now, a method for producing the weather strip 50 will be described below.

FIG. 2 is a schematic view of production processes of the weather strip 50. In producing the weather strip 50, a continuous extruded product before the extruded products are cut to a predetermined dimension is firstly continuously formed by an extrusion molding process.

A metal plate is inserted into an insert punching machine 1 to punch the metal plate to a necessary configuration as an insert. For instance, the insert 54 is formed in which many long strip shaped metal plates are arranged in the direction of width and the long strip shaped metal plates are connected together in connecting parts.

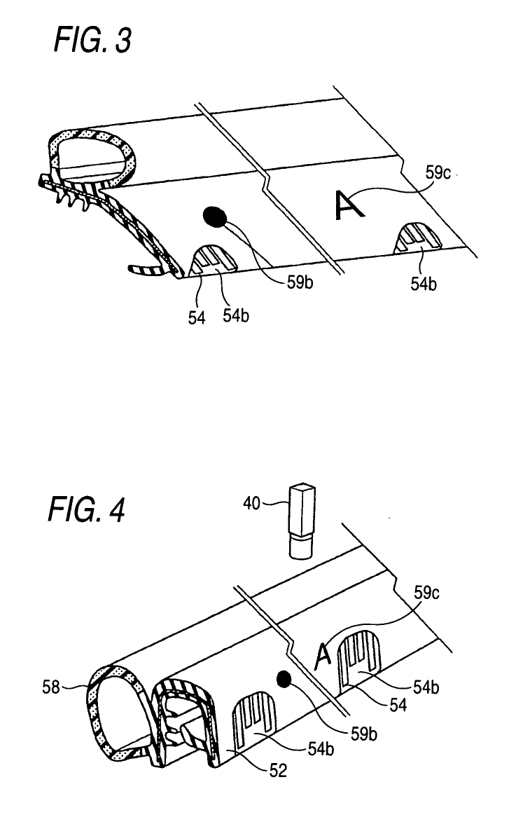

As shown in FIGS. 3 and 4, notch portions 54b are provided in the insert 54 at end parts in the direction of width of a long strip shape of the insert 54 by an insert punching machine 1 at predetermined intervals adapted to the length of a weather strip 50 to be produced. The notch portions 54 allow processing operations after an extrusion molding process to be properly carried out. For instance, the interval of the notch portions 54b is the same as the length of one weather strip 50 to be produced That is, when the notch portions 54b are provided at the front end part and the rear end part of one weather strip 50, the notch portions can be used for cutting the weather strip 50 as the extruded products to a predetermined dimension in the process after the extrusion molding process. Otherwise, when cutting chips are not produced in a terminal end in a cutting process, the notch portion may be provided only at the front end part,

The insert 54 is bent to be slightly bent in a substantially dog-legged shape as shown in FIG. 3 so that a cover material such as rubber is easily extrusion molded in a subsequent extruding process by a pre-forming machine 2 and fed to an extruding head 5 of extruders 3 and 4.

In the extruding head 5, the first extruder 3 extrudes the solid material to cover the insert 54 therewith and form the trim part 52. The second extruder 4 extrudes the sponge material to form the hollow seal part 58. At this time, in the trim part 52, the cover lip 53 is formed at the same time as shown in FIG. 1. In FIGS. 3 and 4, to easily see the notch portions 54b, the cover lip 53 is omitted.

After that, the continuous weather strip 50 is fed to a dimension measuring device 6 to measure the dimensions of the trim part 52, the cover lip 53 and the hollow seal part 58. When the dimensions are located within predetermined ranges, a signal of success is transmitted to a process controller 9. When the dimensions located outside the predetermined ranges, a signal of failure is transmitted to the process controller 9.

Then, the continuous weather strip 50 is sent to a laser marker device 7. The notch portions 54b of the insert 54 are detected by a sensor. On the surface of the cover material of the trim part 52 corresponding to the front end part of the weather strip 50, a product mark 59c is attached as shown in FIG. 3 so that a below-described image recognizing device can recognize a corresponding product. In FIG. 3, as the product mark 59c, “A” of alphabet is attached. This “A” is collated with the corresponding number of goods that is previously stored in the process controller 9 to transmit the target number of goods processed in subsequent processing steps and the specification thereof to a processing device as described below.

Further, the continuous weather strip 50 moves in the dimension measuring device 6. Then, when the notch portion 54b corresponding to the rear end part of the weather strip 50 is detected by the sensor, a success/failure mark 59b is attached to that part by the laser marker device 7. In FIG. 3, as the success/failure mark 59b, in the case of the success, a circular mark is attached.

The success/failure mark 59b and the product mark 59c are provided in the upper surface of the trim part 52 so that the image recognizing device 40 easily recognizes the marks when the trim part 52 is bent in the U shape in section as described below.

Then, the continuous weather strip 50 is moved to a vulcanizing device 8 and heated and vulcanized by hot air or ultrahigh frequency (UHF).

The continuous vulcanized extruded product is continuously conveyed to a bending machine (not shown in the drawing) and bent to the substantially U shape in section by a bending roller of the bending machine. Subsequently, the extruded product is further continuously conveyed so that the cover lip is cut or the extruded product is filled with a sealant, respectively, as described below. Then, the extruded product is cut to a predetermined dimension for each kind of products. The weather strip 50 is one continuous extruded product until the weather strip is cut to a predetermined dimension.

The cut weather strip 50 has its terminal end part formed by a molding process.

Now, the manufacture of the insert will be described below. The insert 54 is firstly manufactured by using an insert forming apparatus (not shown in the drawing) as described above.

A metal plate is inserted to the insert forming apparatus (not shown in the drawing). The metal plate is punched to a configuration required as the insert. Thus, the insert 54 of, for instance, a ladder shape in which many long strip shaped metal plates are arranged in the direction of width and the long strip shaped metal plates are connected together in connecting parts, or the insert 54 of a bone shape of fish is formed.

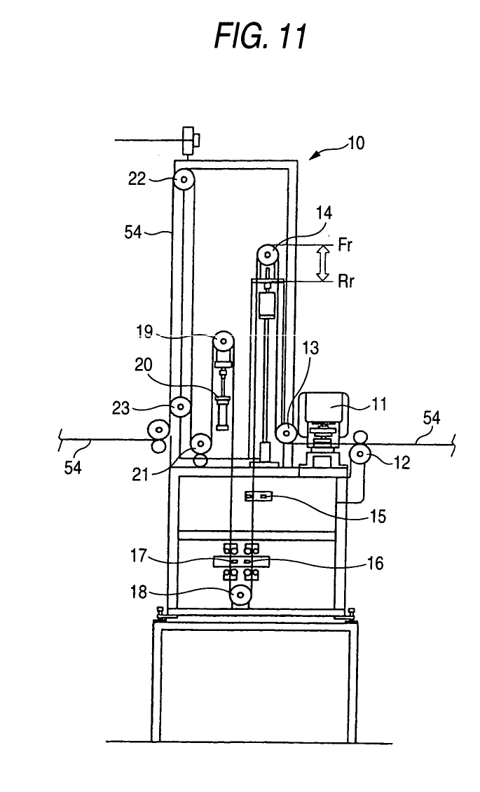

Subsequently, as partly shown in FIGS. 3 and 4, the notch portions 54b are provided at predetermined positions in the side ends of the insert 54 by the insert punching machine 1, FIG. 11 is a front view of the insert punching machine 1.

That is, the metal plate is firstly punched and the insert 54 formed in the ladder shape in which the many long strip shaped metal plates are arranged in the direction of width and the long strip shaped metal plates are connected together in the connecting parts or in the bone shape of fish is inserted into a brake cylinder 12 of the insert punching machine 1 from the right side in FIG. 11.

The insert 54 passing the brake cylinder 12 reaches a punching part 11 to provide the notch portion 54b in a part embedded in the front end of the weather strip 50 upon cutting on the basis of the specification data of products received from a process controller 9. Then, the notch portion 54b reaches a movement adjusting roller 14 via a guide roller 13.

The movement adjusting roller 14 moves upward and downward to provide the notch portions 54b at proper intervals on the basis of the specification data of products received from the process controller 9. As shown in FIG. 11, in the case of the weather strip 50, the insert for a front door (Fr) is longer than the insert for a rear door (Rr). Thus, in the case of the insert for the frontdoor (Fr), the movement adjusting roller 14 is lifted. In the case of the insert for the rear door (Rr), the movement adjusting roller 14 is lowered.

Then, the notch portion 54b reaches a deceleration detector 15 via the movement adjusting roller 14. When the deceleration detector 15 detects the notch portion 54b, the brake cylinder 12 operates and the moving speed of the insert 54 is reduced. Then, when the notch portion 54b reaches a first notch detecting part 16 or a second notch detecting part 17, the first notch detecting part 16 or the second notch detecting part 17 detects the notch portion 54b to stop the movement of the insert 54 and provide a notch portion 54b by the punching part 11. This notch portion 54b is provided in a position embedded in the part of the rear end of the weather strip 50. Accordingly, the cutting positions of the weather strip 50 formed with the extruded products are clearly grasped by the notch portions 54b in the front end and the rear end. Thus, the weather strip 50 high in its dimensional accuracy can be obtained. When a cut part does not produce chips in cutting and can be directly employed for a next product, the notch portion 54b may not be provided in the rear end of the weather strip 50. The notch portion may be provided only in the front end of the weather strip 50 to be subsequently produced.

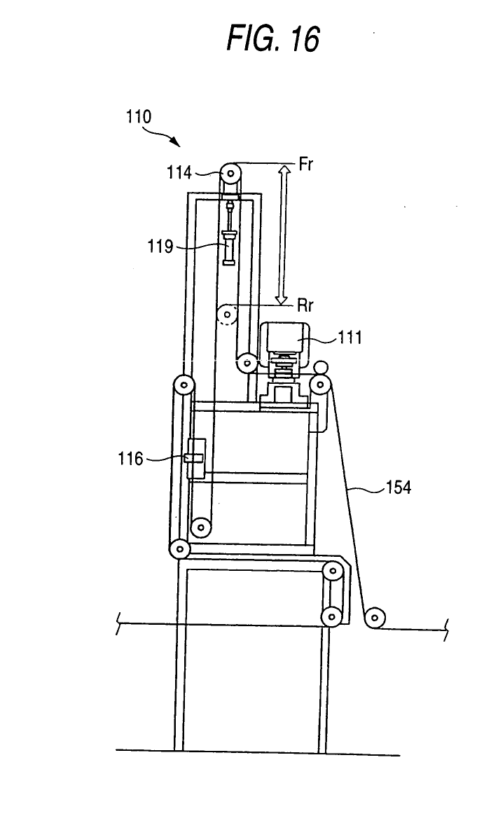

When the insert 54 for the front door (Fr) is changed to the notch portion 54b of the insert 54 for the rear door (Rr), the distance of the notch portions 54b of the insert 54 needs to be decreased. When the insert 54 for the rear door (Rr) is formed, the movement adjusting roller 14 is lowered on the basis of the dimension of the specification data of the product from the process controller 9. Further, a signal is transmitted from the process controller 9 so that the first notch detecting part 16 detects the notch portion 54b. Thus, when the insert 54 for the front door (Fr) is formed, the second notch detecting part 17 detects the notch portion 54b of the insert 54. Accordingly, the moving distance of the movement adjusting roller 14 can be more decreased by the insert 54 between the first notch detecting part 16 and the second notch detecting part 17 than that of the usual movement adjusting roller 114 in FIG. 16.

Therefore, the moving time of the movement adjusting roller 14 is decreased and the movement is completed before the notch portion 54b in the front end of the weather strip 50 reaches the first notch detecting part 16. Consequently, the insert 54 does not become a defective product even while the setting of the movement adjusting roller 14 is changed and can be used as the product.

On the contrary, when the insert 54 for the rear door (Rr) is changed to the notch portion 54b of the insert 54 for the front door (Fr), the distance of the notch portions 54b of the insert 54 needs to be increased. When the insert 54 for the front door (Fr) is formed, the movement adjusting roller 14 is lifted on the basis of the dimension of the specification data of the product from the process controller 9. Further, a signal is transmitted from the process controller 9 so that the second notch detecting part 17 detects the notch portion 54b. When the insert 54 for the rear door (Rr) is formed, the first notch detecting part 16 detects the notch portion 54b of the insert 54. Accordingly, the moving distance of the movement adjusting roller 14 can be more decreased by a distance corresponding to the insert 54 located between the first notch detecting part 16 and the second notch detecting part 17 than that of the usual movement adjusting roller 114 shown in FIG. 16 as described above.

The notch portion 54b detected by the first notch detecting part 16 or the second notch detecting part 17 reaches an impact absorbing roller 19 via a guide roller 18. The impact absorbing roller 19 is held by an air cylinder 20. An impact generated at the time of stopping the movement of the insert 54 when the notch portions 54b are provided in the insert 54 can be absorbed by lowering the impact absorbing roller 19 and the air cylinder 20. Accordingly, the insert 54 can be continuously smoothly manufactured and an extrusion molding process or the like as a subsequent process can be carried out in accordance with a predetermined flow.

Further, the insert 54 (notch portions 54b) is then received by a receiver 21 and fed to an extruder or a pre-forming machine 2 via a moving roller 22 and a guide roller 23. The moving roller 22 serves as an accumulator for feeding the insert 54 to the extruder.

Now, the cutting process of the cover lip, the filling process of the sealant and the cutting process of the extruded products to a predetermined dimension which are the processing steps after the extrusion molding process will be respectively described below.

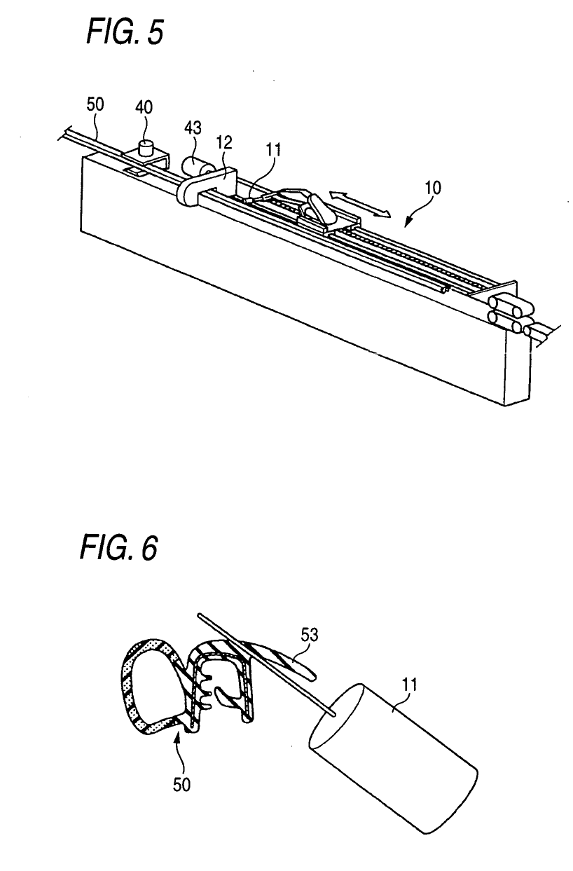

Firstly, the cutting process of the cover lip will be described by referring to FIGS. 5 and 6. FIG. 5 is a perspective view of a cover lip cutting machine 10. The cover lip cutting machine 10 includes the image recognizing device 40, a sensor 43 and a ultrasonic cutter 11.

The continuous weather strip 50 to be cut that is vulcanized in the vulcanizing device 8, bent to the substantially U shape in section and conveyed passes the image recognizing device 40 provided in the cover lip cutting machine 10 and the product mark 59c is recognized therein. The data of the recognized product mark 59c is sent to the process controller 9 to select the specification data of products of an object to be processed The specification of a cutting position of the cover lip 53 that is previously stored in the process controller is selected on the basis of the specification data of the products and the specification data of the cutting position is transmitted to the ultrasonic cutter 11. When the notch portion 54b of the insert 54 provided at the front end part of the weather strip 50 passes the part of the sensor 43 provided in the cover lip cutting machine 10, the sensor 43 detects the notch portion 54b to transmit a signal to the process controller 9 and the ultrasonic cutter 11. The front end part of the product can be recognized in accordance with this signal. The ultrasonic cutter 11 cuts the cover lip 53 of the weather strip 50 conveyed through a guide 12 on the basis of the transmitted specification data of the cutting position as shown in FIG. 6.

The ultrasonic cutter 11 can move synchronously with the movement of the weather strip 50. Accordingly, the blade of the cutter can be put in the direction of width of the cover lip 53.

As described above, the cutting position can be automatically changed in accordance with the specification of the weather strip 50 as the object to be processed by the image recognizing device 40. Thus, many weather strips 50 having different specifications of the cutting positions can be continuously processed. Further, since the product mark 59c is directly attached to the weather strip 50 to be processed and the product mark 59c is automatically recognized, an accurate processing operation can be carried out. Since the start part of a processing part can be clearly grasped by the notch portion 54b of the insert 54 embedded in the weather strip 50, the processing operation can be carried out at a precise position.

FIG. 10 is a detailed sectional view of a part near the sensor 43. The weather strip 50 is guided upward and downward and rightward and leftward by four guide rollers 43c, 43d, 43e and 43f to pass the sensor 43. A magnetic proximity sensor 43b is provided so as to come close to the end of the trim part 52 of the weather strip 50. When the notch portion 54b of the insert 54 embedded in the end of the trim part 52 comes close to the magnetic proximity sensor, the magnetic proximity sensor can detect a magnetic change to detect the notch portion 54b.

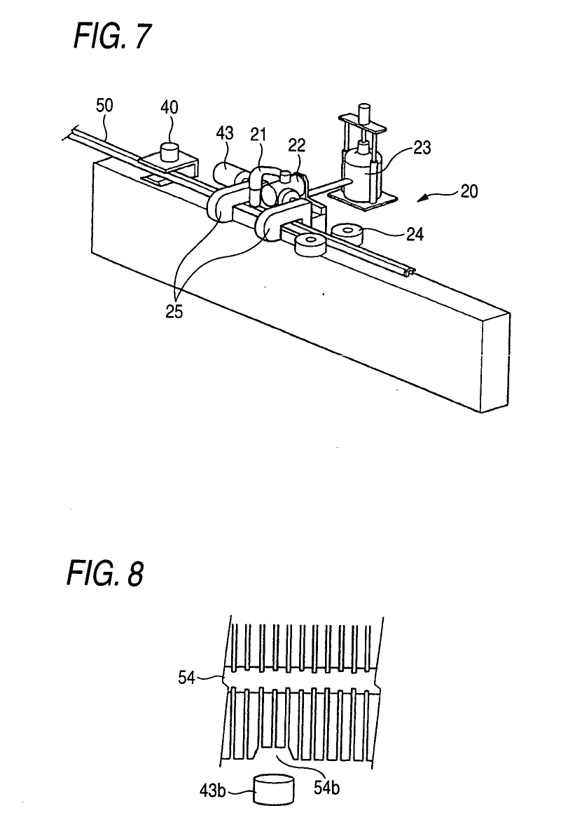

Now, the process that the inner part of the U shape of the trim part 52 of the weather strip 50 is filled with the sealant will be described by referring to FIGS. 7 and 8. FIG. 7 is a perspective view of a sealant filling machine 20. The sealant filling machine 20 includes an image recognizing device 40, a sensor 43 and a sealant injection nozzle 21.

The continuous weather strip 50 to be cut that is vulcanized in the vulcanizing device 8, bent in the substantially U shape in section and conveyed is cut in the cover lip 53 with a part required to be cut by the cover lip cutting machine 10, if necessary, as described above. Then, the obtained weather strip is conveyed to the sealant filling machine 20.

The continuous weather strip 50 having the cover lip 53 cut passes the image recognizing device 40 provided in the sealant filling machine 20 to recognize the product mark 59c therein. The data of the recognized product mark 59c is supplied to the process controller 9 in the same manner as that of the cover lip cutting machine 10 to select the specification data of the products of the object to be processed. Then, the specification of the filling position of the sealant that is previously stored is selected on the basis of the specification data of the products and the specification data of the filling position is transmitted to the sealant filling machine 20.

As shown in FIG. 8, when the notch portion 54b of the insert 54 provided at the front end part of the one weather strip 50 passes a magnetic proximity sensor 43b of the sensor 43 provided in the sealant filling machine 20, the magnetic change of the notch portion 54b is detected by the sensor 43 to transmit a signal to the process controller 9 and the sealant filling machine 20. Thus, the front end position of the product can be recognized in accordance with this signal. A sealant injection pump 22 of the sealant filling machine 20 moves to feed the sealant to the sealant nozzle 21 from a sealant tank 23. The necessary position of the trim part 52 of the weather strip 50 is filled with the sealant from the sealant nozzle 21. The weather strip 50 filled with the sealant is guided by guides 25 and 25, received by receiving rollers 24 and further conveyed to a subsequent process. FIG. 8 schematically shows a positional relation between the notch portion 54b of the insert 54 and the magnetic proximity sensor 43b and does not show the part of the sensor 43 shown in FIG. 7.

As described above, the filling position can be automatically changed in accordance with the specification of the weather strip 50 as the object to be processed by the image recognizing device 40. Accordingly, many weather strips 50 having different specifications of the filling positions can be continuously processed in the same production line. Further, since the product mark 59c is directly attached to the weather strip 50 to be processed and the product mark 59c is recognized, a precise position can be filled with the sealant. Since the start part of the filling position can be clearly grasped by the notch portion 54b of the insert 54 embedded in the weather strip 50, a precise processing operation can be carried out.

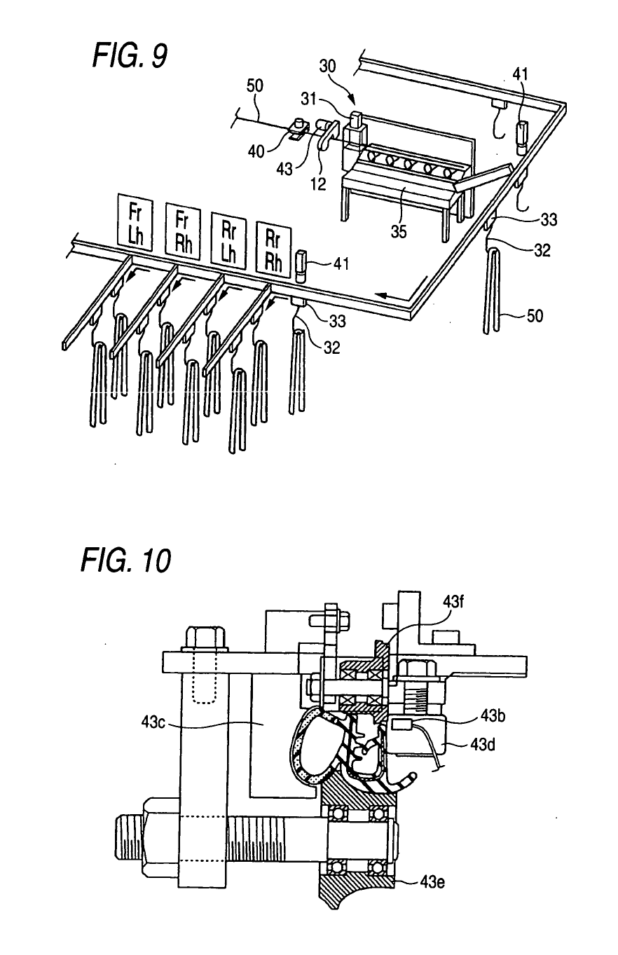

Now, a process that the weather strip 50 is cut to a predetermined dimension will be described below with reference to FIG. 9. FIG. 9 is a perspective view of a weather strip cutting device 30.

The weather strip cutting device 30 includes an image recognizing device 40, a sensor 43, a cutter 31 a mounting base 35 and a work conveying device 32.

The continuous weather strip 50 to be cut that is vulcanized in the vulcanizing device 8, bent in the substantially U shape in section and conveyed is cut in the cover lip 53 by the cover lip cutting machine 10, if necessary, as described above. Then, the obtained weather strip is filled with the sealant by the sealant filling machine 20 and conveyed to the weather strip cutting device 30.

The continuous weather strip 50 that is filled with the sealant by the sealant filling machine 20 passes the image recognizing device 40 provided in the weather strip cutting device 30 to recognize the product mark 59c therein. The data of the recognized product mark 59c is sent to the process controller 9 to select the specification data of the products of the object to be processed in the same manner as that of the sealant filling machine 20. Thus, a cutting dimension that is previously stored is selected on the basis of the specification data of the products and the data of the cutting dimension is transmitted to the weather strip cutting device 30.

As shown in FIG. 8, when the notch portion 54b of the insert 54 provided in the front end part of the one weather strip 50 passes the part of a magnetic proximity sensor 43b of the sensor 43 provided in the weather strip cutting device 30, the sensor 43 detects the notch portion 54b to transmit a signal to the process controller 9 and the weather strip cutting device 30. Further, when the weather strip 50 moves on the mounting base 35 of the weather strip cutting device 30 and the rear end part of the weather strip 50 passes the part of the magnetic proximity sensor 43b of the sensor 43, the magnetic proximity sensor 43b detects the notch portion 54b. Further, the rear end part of the weather strip passes the image recognizing device 40 to recognize the success/failure mark 59b attached to the weather strip 50 and transmit a signal to the weather strip cutting device 30.

Then, the cutting dimension transmitted from the process controller 9 is collated with the detected data of the notch portions 54b of the insert 54 provided in the front end part and the rear end part of the weather strip 50 to cut the continuous weather strip 50 located on the mounting base 35 to a predetermined dimension by the cutter 31.

The cut weather strips 50 are sorted to successful products and unsuccessful products in accordance with the success/failure mark 59b. The successful products are automatically hooked on the work conveying device 32. In the work conveying device 32, a bar code display part 33 to which a bar code is attached is provided. The bar code of the bar code display part 33 is read by a bar code recognizing device 41 to transmit the number of goods of the weather strip 50 hooked on the work conveying device 32 to the process controller 9. The numbers of goods are collated with the data of storage positions respectively for the products that is registered in the process controller 9.

The work conveying device 32 automatically moves on a moving rack to select the storage position by the bar code recognizing device 41 on the basis of the above-described collation. The weather strips 50 are respectively sent to predetermined positions for corresponding numbers of goods.

Subsequently, a terminal end is processed as required, The terminal ends are processed by a molding process by inserting the terminal ends of the cut weather strips 50 into metal molds for molding the terminal ends that have shapes respectively determined in accordance with the numbers of goods. In this case, the weather strips 50 have the numbers of goods respectively recognized by the bar codes as described above so that a terminal molding process can be properly carried out.

Second Embodiment

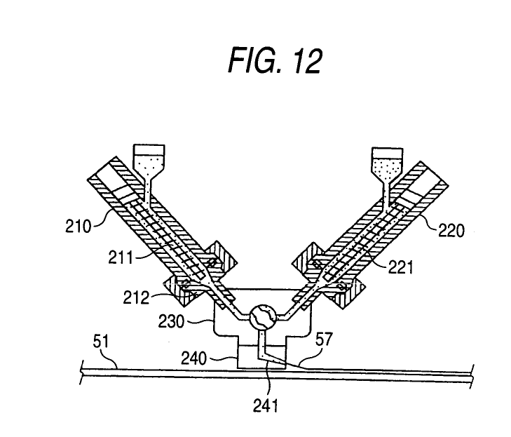

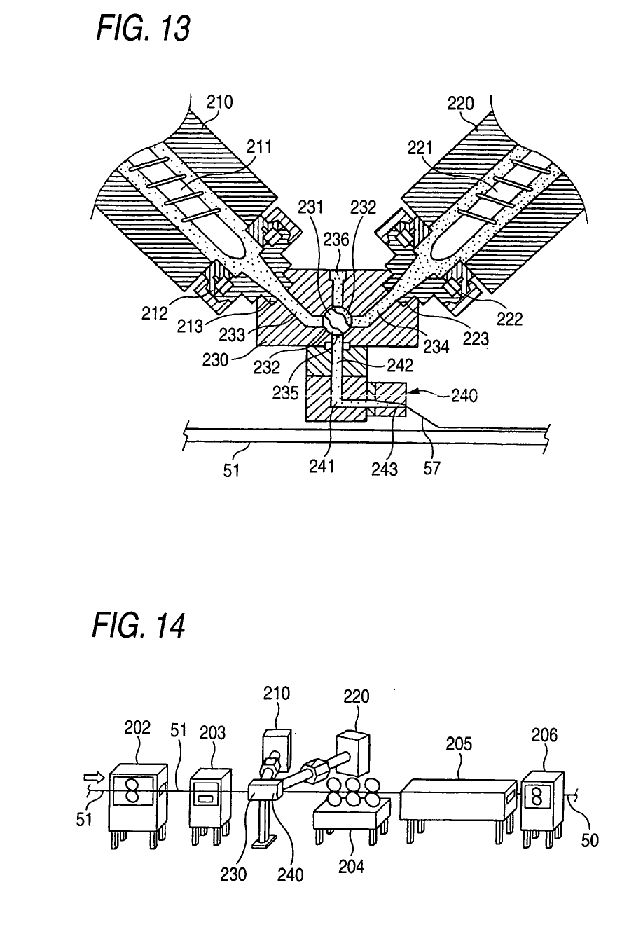

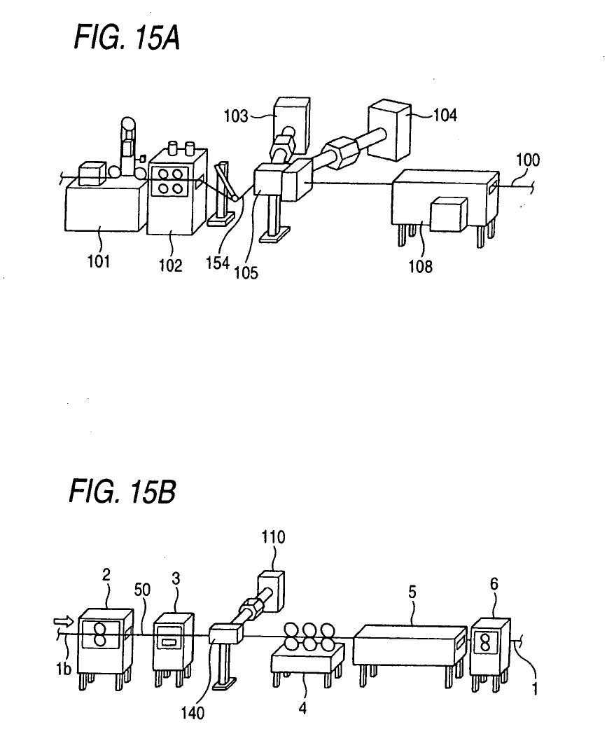

A method for producing a weather strip 250 of the second embodiment is described with reference to FIGS. 12-13. FIG. 14 is a schematic view showing a part of a production line of the weather strip 250.

In the weather strip 50, a weather strip main body 51 is firstly formed by an extruder (not shown in the drawing). An insert 54 is supplied to the extruder. A solid material forming a trim part 52 and a cover lip 53 and a sponge material forming a hollow seal part 58 are simultaneously extruded by the extruder to extrusion mold the weather strip main body 51. Then, when these materials are rubber, the weather strip main body is moved to a high frequency heating furnace, a hot air heating furnace or the like to heat and vulcanize the weather strip main body.

The vulcanized weather strip main body 51 is fed to a primary pre-forming machine 202 as shown in FIG. 14. The weather strip main body is slightly bent by rollers of the pre-forming machine 202 therein so that a primer is easily applied or a cover layer (decorative layer) 57 is easily stuck thereto.

After the pre-forming machine 202, the weather strip main body 51 is fed to a primer applicator 203. In the primer applicator, the primer is applied to a part in which the upper surface of the trim part 52 of the weather strip main body 51 is fixed to the cover layer 57 of the cover lip 53 to strengthen the sticking force of the cover layer 57.

The weather strip main body 51 to which the primer is applied is fed to a part of an extruding die 240 connected to a selector valve 230 to which nozzles of a first extruder 210 and a second extruder 220 are respectively attached. In this extruding die, the cover layer 57 having a color corresponding to an interior finish in a vehicle is extruded in the form of a sheet on the upper surfaces of the trim part 52 and the cover lip 53 of the weather strip main body 51 (see FIGS. 12 and 13). The extrusion of the cover layer 57 and the detail of the selector valve 230 and the extruding die 240 will be described below.

The weather strip main body 51 in which the cover layer 57 is extruded on the upper surfaces of the trim part 52 and the cover lip 53 is fed to a bonding machine 204 as shown in FIG. 14. The cover layer 57 is fixed and pressed to the weather strip main body 51 by rollers. The end part of the side part of the cover layer 57 is wound to the back surface of an end of the cover lip 53 to fix and press the weather strip main body 51 to the cover layer 57. At this time, the weather strip main body 51 remains to be warm after a vulcanizing process. Further, since the cover layer 57 has just extruded, the cover layer 57 is in a state of high temperature. Thus, the cover layer 57 is strongly stuck to the weather strip main body 51 with the assistance of the adhesive action of the primer.

Further, in the case of the same kinds of materials or the same materials having a compatibility with each other, for instance, when the weather strip main body 51 is formed with EPDM and the cover layer 57 is formed with an olefin thermoplastic elastomer, the cover layer 57 is more strongly fixed to the weather strip main body 51.

The weather strip 50 to which the cover layer 57 is fixed is fed to a cooling device 205 and cooled by water or cold air.

The weather strip 50 taken out from the cooling device 205 is pulled by a sending machine 206 and cut to a predetermined dimension. Then, the weather strip undergoes an injection molding process to a door or a corner part of a vehicle body to have a molded part. Further, depending on the weather strip, a double side adhesive tape or a clip or the like is attached to the weather strip to obtain a product.

Now, a step for extrusion molding the cover layer 57 and fixing the cover layer 57 to the weather strip main body 51 will be described in detail by referring to FIGS. 12 and 13.

FIG. 12 is a sectional view of the step for extrusion molding the cover layer 57. FIG. 13 is a detailed sectional view of parts of a head, the selector valve 230 and the extruding die 240 of the extruding machine for extrusion molding the cover layer 57 in FIG. 12.

When the cover layer 57 is provided on the upper surfaces of the trim part 52 and the cover lip 53 of the weather strip main body 51, a screw 211 or 221 of the first extruder 210 or the second extruder 220 is firstly rotated as shown in FIG. 12 to extrude the material of the cover layer 57 to the selector valve 230. The extruding material is fed to the extruding die 240 via the selector valve 230 and extruded in the form of the sheet with a predetermined thickness from the extruding die 240.

More specifically, when the screw 211 of the first extruder 210 is rotated, the material of the cover layer 57 in a cylinder is plasticized to feed the material from an extruding head 212 to the selector valve 230.

The material fed to the selector valve 230 passes a first inlet passage 233 of the selector valve 230 and reaches a first outlet passage 235 via a rotor groove 232 provided in a rotor 231, as shown in FIG. 13. Then, the material is fed to the extruding die 240 connected to the selector valve 230. The first outlet passage 235 of the selector valve 30 communicates with a die passage 241 of the extruding die 240. Accordingly, the material of the cover layer 57 enters from an inlet 242 of the die passage, passes the die passage 241 and is extruded from an outlet 243 of the die passage so as to be mounted on the upper surface of the weather strip main body 51 in the form of the sheet as the cover layer 57.

Then, when a sensor (not shown in the drawing) provided before the step of extruding the cover layer 57 recognizes notch portions provided in the insert 54 embedded in the weather strip main body 51 or symbols or characters provided on the surface of the weather strip main body 51 to recognize that the cover layer 57 of a product as an object to be produced is to be changed, a signal from the sensor is transmitted to an extrusion molding controller. Then, a signal for changing the material of the cover layer 57 is sent to the selector valve 230 from the extrusion molding controller. Thus, the rotor 31 of the selector valve 230 rotates to allow a second inlet passage 234 to communicate with the rotor groove 232 and the first outlet passage 235. Then, a material is fed to the selector valve 230 from the second extruder 220 by the screw 222.

The material sent to the selector valve 230 passes the second inlet passage 234 of the selector valve 230 and reaches the first outlet passage 235 via the rotor groove 232 provided in the rotor 231. Then, the material is fed to the extruding die 240 connected to the selector valve 230 like the above-described cover layer 57. The first outlet passage 235 of the selector valve 230 communicates with the die passage 241 of the extruding die 240. Accordingly, the material of the cover layer 57 enters from the inlet 242 of the die passage, passes the die passage 241 and is extruded from the outlet 243 of the die passage so as to be mounted on the upper surface of the weather strip main body 51 in the form of the sheet as the cover layer 57.

Now, the change of the material of the cover layer 57 will be described below. When a signal for preparing for molding a next cover layer 57 is received from the extrusion molding controller for controlling the production line, before the first extruder 210 is switched to the second extruder 220, the material of the second extruder 220 is completely plasticized. To realize a steady state of the flow of the material, the second extruder 220 is warmed up. In the warming up operation, as shown in FIG. 13, the screw 221 of the second extruder 220 is rotated to plasticize the material in a cylinder. The material is fed to the second inlet passage 234 of the selector valve 230 via a nozzle 223 from the extruding head 222. Then, the material is supplied to a second outlet passage 236 from another rotor groove 232 of the rotor 231. Then, the material in a warming-up state is discharged outside from the second outlet passage 236 or fed back to a part near a material charging port of the second extruder 220 to circulate the material. Thus, before the selector valve 230 is switched, the second extruder 220 can be warmed up. The warming-up operation enables the second extruder 220 to perform a smooth extrusion molding process of the cover layer 57 immediately after the selector valve 230 is switched.

When a command for preparing for molding a next cover layer 57 is inputted from the extrusion molding controller, this warming-up operation can be carried out. While the first extruder 210 extrusion molds the cover layer 57, the second extruder can be warmed-up. The material can be switched without taking much time.

Further, the material can be changed only by rotating the selector valve 230. Accordingly, an excessive cover layer 57 extruded on the weather strip main body 51 by changing the material is only a material remaining in the die passage 241 of the extruding die 240 from the selector valve 230. Thus, a loss caused by changing the material can be reduced to a minimum.

Further, when a command for preparing for molding a next cover layer 57 is inputted, the first extruder 210 side is warmed up as described above. At this time, the material of the first extruder 210 is further changed to a material corresponding to the next cover layer 57. The material is changed while the second extruder 220 operates. Accordingly, even when the material is changed, the production line is not stopped.

1. A method for producing extruded products of plural specifications in a single production line controlled by a process controller; said method comprising:
an extrusion step of extruding a continuous extruded product by an extrusion molding in accordance with a signal from the process controller;
a symbol providing step of providing a symbol on a surface of the extruded product during the extrusion molding based on a predetermined specification data from the process controller; and
a processing step of processing the long molded part;
wherein the processing step includes:
recognizing an image of the symbol provided on the surface of the extruded product;
transmitting a product identification signal based on the recognized image to the process controller,
identifying the extruded product to be produced in accordance with the product identification signal in the process controller,
selecting a specification data of the extruded product based on the production identification signal in the process controller,
sending the specification data to a processing system,
performing a predetermined processing work in accordance with the specification data to the extruded product in the processing system;
wherein the processing work based on the specification data is automatically switchable so that the plural extruded products having the different specifications are formed in the single production line.

2. A method for producing extruded products according to claim 1, further comprising:
a step for providing a metal insert in which a notch portion is formed,
wherein, in the processing step, both the product identification signal based on the recognized image and a signal obtained by detecting the notch portion of the metal insert by a sensor are used in the processing step.

3. A method for producing extruded products according to claim 1, wherein the extruded product is a weather strip for sealing a peripheral portion of an opening part of a vehicle.

4. A method for producing extruded products according to claim 1, wherein the processing step includes a step for cutting the extruded product to a predetermined dimension.

5. A method for producing extruded products according to claim 3, wherein the processing step includes a step for filling an inner part of a trim part of the weather strip with a sealant.

6. A method for producing extruded products according to claim 3, wherein the processing step includes a step for partly cutting a cover lip of the weather strip by a predetermined dimension at a predetermined position.

7. A method for producing extruded products of plural specifications in a single production line controlled by a process controller; said method comprising the steps of:
a notch forming step of forming a notch portion in a metal insert based on a predetermined specification data of the extruded product to be produced from the process controller;
an extruding step of extruding a continuous extruded product so as to embed the metal insert with the notch portion by extrusion molding;
a processing step of processing the long molded part;
wherein the processing step includes:
detecting the notch portion embedded in the extruded product by a sensor,
transmitting a signal from the sensor to the process controller,
identifying the extruded product to be produced in accordance with the signal from the sensor in the process controller,
selecting a specification data of the extruded product of the extruded product in accordance with the extruded product to be produced; and
sending the specification data to a processing system,
performing a predetermined processing work in accordance with the specification data to the extruded product in the processing system;
wherein a processing work based on the specification data is automatically switchable so that the plural extruded products having the different specifications are formed in the single production line.

8. A method for producing extruded products according to claim 7, wherein the extruded product is a weather strip for sealing a peripheral portion of an opening part of a vehicle.

9. A method for producing extruded products according to claim 7, wherein the notch portion is partly formed on a side end portion in a width direction of the insert by an insert punching machine and
the insert having the notch portion is covered with a soft material forming the extruded product by an extruder;
the insert punching machine includes
a punching part that receives a specification data of the molded product from the process controller that is related to an interval length of notch portions adjacent to each other in inserts to be produced and forms a notch portion in a front end part of the insert which is embedded in one extruded product,
a first notch detecting part for detecting the notch portion after the notch portion moves by a predetermined length from the punching part,
an insert length adjusting part for adjusting the length of the insert between the punching part and the first notch detecting part based on the specification data of the extruded product provided from the process controller, and
a second notch detecting part at a position where the notch portion moves by a predetermined length from the first notch detecting part,
the method further comprising:
the insert is moved after the notch portion corresponding to a front end part of the extruded product to be produced is formed in the insert; and
a movement adjusting roller is movable so that an interval of the notch portions becomes a predetermined length based on the specification data transmitted from the process controller in case that the longitudinal dimension of the extruded product is changed,
such that if the longitudinal dimension of the extruded product becomes shorter, the first notch detecting part detects a position at which a next notch portion is to be formed for a rear end part of the extruded product or a front end part of the next extruded product; and
if the longitudinal dimension of the extruded product becomes longer, the second notch detecting part detects a position at which a next notch portion is to be formed for the rear end part of the extruded product or the front end part of the next extruded product.

10. A method for producing extruded products according to claim 9, wherein the insert punching machine has an impact absorbing roller for absorbing the impact of the punching part.

11. A method for producing extruded products according to claim 9, wherein the insert length adjusting part includes the movement adjusting roller movable in the same direction as the moving direction of the insert or in an opposite direction thereto.

12. A method for producing extruded products according to claim 9, wherein a moving speed of the movement adjusting roller is lower than a moving speed of the insert.

13. A method for producing extruded products according to claim 9, wherein a deceleration detector for detecting a moving speed of the insert is provided in a vicinity of a first notch detecting part.

14. A method for producing extruded products having a cover layer on a surface thereof, said method including
two extruders for forming the cover layers on the surface of the extruded product and a cover layer forming device; respectively different extrusion molding materials being supplied to the two extruders, nozzles of the two extruders being respectively connected to a selector valve and a cover layer extruding die being attached to the selector valve, said method comprising:
a extrusion step of extruding a extruded product by extrusion molding and
a cover layer forming step of forming the cover layer by the cover layer forming device continuously from the extrusion step,
wherein when the cover layer forming device receives a signal for forming a product having a different cover layer from an extrusion molding controller in the cover layer forming step, the selector valve of the cover layer forming device is switched to continuously move the extruded product and extruding the cover layer made of the different extrusion molding material on the extruded product.

15. A method for producing extruded products according to claim 14, wherein said another extruder is warmed up before the cover layer is formed by switching the selector valve from one extruder to another extruder.

16. A method for producing extruded products according to claim 15, wherein the extruded product is made of EPDM and the cover layer is formed with olefin thermoplastic elastomer.

17. A method for producing extruded products according to claim 14, further comprising:
a symbol providing step of providing a symbol on a surface of the extruded product during the extrusion molding based on a predetermined specification data from the process controller; and
a processing step of processing the long molded part;
wherein the processing step includes;
recognizing an image of the symbol provided on the surface of the extruded product;
transmitting a product identification signal based on the recognized image to the process controller, identifying the extruded product to be produced in accordance with the product identification signal in the process controller,
selecting a specification data of the extruded product based on the production identification signal in the process controller,
sending the specification data to a processing system,
performing a predetermined processing work in accordance with the specification data to the extruded product in the processing system;
wherein the processing work based on the specification data is automatically switchable so that the plural extruded products having the different specifications are formed in the single production line.

18. A method for producing extruded products according to claim 14, further comprising:
a step for providing a metal insert in which a notch portion is formed,
wherein, in the processing step, both the product identification signal based on the recognized image and a signal obtained by detecting the notch portion of the metal insert by a sensor are used in the processing step.
